(19) United States
(12) Patent Application Publication
(10) Pub. No.: US 2019/0155373 A1
(43) Pub. Date: May 23, 2019

(54) SYSTEM AND METHODS FOR INFUSION RANGE SENSOR

(71) Applicant: Tactual Labs Co., New York, NY (US)

(72) Inventors: David Holman, Toronto (CA); Ricardo Jorge Jota Costa, Toronto (CA); Bruno Rodrigues De Araujo, Toronto (CA); Jonathan Deber, Toronto (CA)

(73) Assignee: Tactual Labs Co., New York, NY (US)

(21) Appl. No.: 16/193,476

(22) Filed: Nov. 16, 2018

Related U.S. Application Data
(60) Provisional application No. 62/588,148, filed on Nov. 17, 2017.

(51) Int. Cl. G06F 3/01; G06F 3/044

(52) U.S. Cl. CPC G06F 3/011; G06F 3/044; G06F 3/0418; G06F 2203/04108; G06F 2203/04104

(57) ABSTRACT

A method and system for determining distance from a conductor. A signal is infused into object or into a body part. Calibration occurs by moving the object to at least two known distances and measuring the signal. Using the measured signals, a signal-to-distance map can be created and used to determine the distances of additional objects or body parts.

This application claims the benefit of U.S. Provisional Application Ser. No. 62/588,148, entitled “System and Methods for Infusion Range Sensor,” filed Nov. 17, 2017, the contents of which are hereby incorporated herein by reference. It is related to U.S. Provisional Patent Application No. 62/428,862, entitled “Signal Injection to Enhance Appendage Detection and Characterization,” filed Dec. 1, 2016; U.S. Provisional Patent Application No. 62/473,908, entitled “Hand Sensing Controller,” filed Mar. 20, 2017; and U.S. Provisional Patent Application No. 62/488,753, entitled “Heterogeneous Sensing Apparatus And Methods,” filed Apr. 22, 2017 the contents of all of the aforementioned applications hereby incorporated herein by reference.

### FIELD OF THE INVENTION

The disclosed system and methods relate in general to the field of sensing, and in particular to an infusion sensor for measuring range.

### BRIEF DESCRIPTION OF THE DRAWINGS

The foregoing and other objects, features, and advantages of the disclosure will be apparent from the following more particular descriptions of embodiments as illustrated in the accompanying drawings, in which the reference characters refer to the same parts throughout the various views. The drawings are not necessarily to scale, with emphasis instead being placed upon illustrating principles of the disclosed embodiments.

FIG. 1 shows an exemplary system illustrating an embodiment of the disclosure with a hand in a first position.

FIG. 2 is another view of the system shown in FIG. 1, with the hand in a different position.

FIG. 3 is yet another view of the system shown in FIG. 1, with the hand in a different position.

FIG. 4 is yet another view of the system shown in FIG. 1.

FIG. 5 is a schematic view of a conductor used in connection with the embodiment shown in FIGS. 1-4.

FIG. 6 is a schematic view of a conductor arrangement used in connection with an embodiment of the disclosure.

FIG. 7 is a schematic view of a conductor arrangement used in connection with an embodiment of the disclosure.

FIG. 8 is a schematic view of a conductor arrangement that used in connection with an embodiment of the disclosure.

FIG. 9 is another schematic view of the conductor arrangement shown in FIG. 8 used in connection with an embodiment of the disclosure.

FIG. 10 is a schematic view of a conductor arrangement used in connection with an embodiment of the disclosure.

FIG. 11 is another schematic view of the conductor arrangement shown in FIG. 10 used in connection with an embodiment of the disclosure.

FIG. 12 is a schematic view of a conductor used in connection with an embodiment of the disclosure.

FIG. 13 is a schematic view of a conductor arrangement used in connection with an embodiment of the disclosure.

FIG. 14 is a schematic view of a conductor used in connection with an embodiment of the disclosure.

FIG. 15 is a schematic view of a conductor used in connection with an embodiment of the disclosure.

FIG. 16 is a schematic view of a conductor used in connection with an embodiment of the disclosure.

FIG. 17 is another schematic view of the conductor shown in FIG. 16 used in connection with an embodiment of the disclosure.

FIG. 18 is a schematic view of a conductor used in connection with an embodiment of the disclosure.

FIG. 19 is a schematic view of a conductor that can be used in connection with an embodiment of the disclosure.

FIG. 20 is an illustration of two regressions of infusion signal data.

### DETAILED DESCRIPTION

The present application contemplates various embodiments of sensors designed for signal infusion range sensing. The sensor configurations are suited for use with frequency-orthogonal signaling techniques (see, e.g., U.S. Pat. Nos. 9,019,224 and 9,529,476, and U.S. Pat. No. 9,811,214, all of which are hereby incorporated herein by reference). The sensor configurations discussed herein may be used with other signal techniques including scanning or time division techniques, and/or code division techniques.

The presently disclosed systems and methods involve principles related to and for designing, manufacturing and using capacitive based sensors, and particularly capacitive based sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. As such, this application incorporates herein by reference Applicant's prior U.S. Pat. No. 9,019,224, entitled “Low-Latency Touch Sensitive Device” and U.S. Pat. No. 9,158,411 entitled “Fast Multi-Touch Post Processing.” These applications contemplate FDM, CDM, or FDM/CDM hybrid touch sensors which may be used in connection with the presently disclosed sensors. In such sensors, interactions are sensed when a signal from a row is coupled (increased) or decoupled (decreased) to a column and the result received on that column. By sequentially exciting the rows and measuring the coupling of the excitation signal at the columns, a heatmap reflecting capacitance changes, and thus proximity, can be created.

This application also employs principles used in fast multi-touch sensors and other interfaces disclosed in the following: U.S. Pat. Nos. 9,933,880; 9,019,224; 9,811,214; 9,804,721; 9,710,113; and 9,158,411. Familiarity with the disclosure, concepts and nomenclature within these patents is presumed. The entire disclosure of those patents and the applications incorporated therein by reference are incorporated herein by reference. This application also employs principles used in fast multi-touch sensors and other interfaces disclosed in the following: U.S. patent application Ser. Nos. 15/162,240; 15/690,234; 15/195,675; 15/200,642; 15/821,677; 15/904,953; 15/905,465; 15/943,221; 62/540,458, 62/575,005, 62/621,117, 62/619,656 and PCT publication PCT/US2017/050547, familiarity with the disclosures, concepts and nomenclature therein is presumed. The entire disclosure of those applications and the applications incorporated therein by reference are incorporated herein by reference.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency-orthogonal to each other, in which case, they could not be the same frequency.

Certain principles of a fast multi-touch (FMT) sensor have been disclosed in patent applications discussed above. Orthogonal signals are transmitted into a plurality of transmitting conductors (or antennas) and the information received by receivers attached to a plurality of receiving conductors (or antennas), the signal is then analyzed by a signal processor to identify touch events. The transmitting conductors and receiving conductors may be organized in a variety of configurations, including, e.g., a matrix where the crossing points form nodes, and interactions are detected at those nodes by processing of the received signals. In an embodiment where the orthogonal signals are frequency orthogonal, spacing between the orthogonal frequencies, Δf, is at least the reciprocal of the measurement period T, the measurement period T being equal to the period during which the columns are sampled. Thus, in an embodiment, a column may be measured for one millisecond (τ) using frequency spacing (Δf) of one kilohertz (i.e., Δf=1/τ).

In an embodiment, the signal processor of a mixed signal integrated circuit (or a downstream component or software) is adapted to determine at least one value representing each frequency orthogonal signal transmitted to a row. In an embodiment, the signal processor of the mixed signal integrated circuit (or a downstream component or software) performs a Fourier transform to received signals. In an embodiment, the mixed signal integrated circuit is adapted to digitize received signals. In an embodiment, the mixed signal integrated circuit (or a downstream component or software) is adapted to digitize received signals and perform a discrete Fourier transform (DFT) on the digitized information. In an embodiment, the mixed signal integrated circuit (or a downstream component or software) is adapted to digitize received signals and perform a Fast Fourier transform (FFT) on the digitized information—an FFT being one type of discrete Fourier transform.

It will be apparent to a person of skill in the art in view of this disclosure that a DFT, in essence, treats the sequence of digital samples (e.g., window) taken during a sampling period (e.g., integration period) as though it repeats. As a consequence, signals that are not center frequencies (i.e., not integer multiples of the reciprocal of the integration period (which reciprocal defines the minimum frequency spacing)), may have relatively nominal, but unintended consequence of contributing small values into other DFT bins. Thus, it will also be apparent to a person of skill in the art in view of this disclosure that, the term orthogonal as used herein is not “violated” by such small contributions. In other words, as we use the term frequency orthogonal herein, two signals are considered frequency orthogonal if substantially all of the contribution of one signal to the DFT bins is made to different DFT bins than substantially all of the contribution of the other signal.

In an embodiment, received signals are sampled at at least 1 MHz. In an embodiment, received signals are sampled at at least 2 MHz. In an embodiment, received signals are sampled at 4 Mhz. In an embodiment, received signals are sampled at 4.096 Mhz. In an embodiment, received signals are sampled at more than 4 MHz.

To achieve kHz sampling, for example, 4096 samples may be taken at 4.096 MHz. In such an embodiment, the integration period is 1 millisecond, which per the constraint that the frequency spacing should be greater than or equal to the reciprocal of the integration period provides a minimum frequency spacing of 1 KHz. (It will be apparent to one of skill in the art in view of this disclosure that taking 4096 samples at e.g., 4 MHz would yield an integration period slightly longer than a millisecond, and not achieving kHz sampling, and a minimum frequency spacing of 976.5625 Hz.) In an embodiment, the frequency spacing is equal to the reciprocal of the integration period. In such an embodiment, the maximum frequency of a frequency-orthogonal signal range should be less than 2 MHz. In such an embodiment, the practical maximum frequency of a frequency-orthogonal signal range should be less than about 40% of the sampling rate, or about 1.6 MHz. In an embodiment, a DFT (which could be an FFT) is used to transform the digitized received signals into bins of information, each reflecting the frequency of a frequency-orthogonal signal transmitted which may have been transmitted by the transmit antenna 130. In an embodiment 2048 bins correspond to frequencies from 1 KHz to about 2 MHz. It will be apparent to a person of skill in the art in view of this disclosure that these examples are simply that, exemplary. Depending on the needs of a system, and subject to the constraints described above, the sample rate may be increased or decreased, the integration period may be adjusted, the frequency range may be adjusted, etc.

In an embodiment, a DFT (which can be an FFT) output comprises a bin for each frequency-orthogonal signal that is transmitted. In an embodiment, each DFT (which can be an FFT) bin comprises an in-phase (I) and quadrature (Q) component. In an embodiment, the sum of the squares of the I and Q components is used as measure corresponding to signal strength for that bin. In an embodiment, the square root of the sum of the squares of the I and Q components is used as measure corresponding to signal strength for that bin. It will be apparent to a person of skill in the art in view of this disclosure that a measure corresponding to the signal strength for a bin could be used as a measure related to biometric activity. In other words, the measure corresponding to signal strength in a given bin would change as a result of some activity.

Generally, as the term is used herein, injection or infusion refers to the process of transmitting signals to the body of a subject, effectively allowing the body (or parts of the body) to become an active transmitting source of the signal. In an embodiment, an electrical signal is injected into the hand (or other part of the body) and this signal can be detected by a sensor even when the hand (or fingers or other part of the body) are not in direct contact with the sensor's touch surface. To some degree, this allows the proximity and orientation of the hand (or finger or some other body part) to be determined, relative to a surface. In an embodiment, signals are carried (e.g., conducted) by the body, and depending on the frequencies involved, may be carried near the surface or below the surface as well. In an embodiment, frequencies of at least the KHz range may be used in frequency infusion. In an embodiment, frequencies in the MHz range may be used in frequency infusion. To use infusion in connection with FMT as described above, in an embodiment, an infusion signal can be selected to be orthogonal to the drive signals, and thus it can be seen in addition to the other signals on the sense lines.

The sensing apparatuses discussed herein use transmitting and receiving antennas (also referred to herein as conductors). However, it should be understood that whether the transmitting antennas or receiving antennas are functioning as a transmitter, a receiver, or both depends on context and the embodiment. In an embodiment, the transmitters and receivers for all or any combination of the patterns are operatively connected to a single integrated circuit capable of transmitting and receiving the required signals. In an embodiment, the transmitters and receivers are each operatively connected to a different integrated circuit capable of transmitting and receiving the required signals, respectively. In an embodiment, the transmitters and receivers for all or any combination of the patterns may be operatively connected to a group of integrated circuits, each capable of transmitting and receiving the required signals, and together sharing information necessary to such multiple IC configuration. In an embodiment, where the capacity of the integrated circuit (i.e., the number of transmit and receive channels) and the requirements of the patterns (i.e., the number of transmit and receive channels) permit, all of the transmitters and receivers for all of the multiple patterns used by a controller are operated by a common integrated circuit, or by a group of integrated circuits that have communications therebetween. In an embodiment, where the number of transmit or receive channels requires the use of multiple integrated circuits, the information from each circuit is combined in a separate system. In an embodiment, the separate system comprises a graphic processing unit (GPU) and software for signal processing.

Signal infusion (a/k/a signal injection) can be used to enhance appendage detection and characterization. See, e.g., U.S. Provisional Patent Application No. 62/428,862 filed Dec. 1, 2016. Signal infusion can also be combined with capacitive sensing to provide more signal, and thus, better track, e.g., touch. See, e.g.: U.S. Provisional Patent Application No. 62/473,908, entitled “Hand Sensing Controller,” filed Mar. 20, 2017; and U.S. Provisional Patent Application No. 62/488,753, entitled “Heterogeneous Sensing Apparatus and Methods,” filed Apr. 22, 2017. The contents of the aforementioned patents are incorporated herein by reference.

Signal infusion can be deployed for detection of objects at a wide variety of distances within the operative range of the sensor. In an embodiment, signal infusion can be deployed for detection of objects at distances up to and greater than 1 cm from the sensor. In an embodiment, signal infusion is deployed for detection of objects at distances up to and in excess of 5 cm from the sensor. In an embodiment, signal infusion is deployed for detection of objects at distances up to and in excess of 10 cm from the sensor. In an embodiment, signal infusion is deployed for detection of objects at distances up to and in excess of 25 cm. As discussed hereinbelow, in experiments signal infusion is deployed for detection of objects up to and including distances of 256 mm.

It has now been discovered, as is further disclosed hereinbelow, that, in an embodiment, in addition to object detection, a sensor can use infusion to measure distance from the sensor of an object. The distance can be measured to within a useful range of the sensor. In an embodiment, an infusion sensor can comprise a plurality of sensing elements, such as conductors or antennas, that can each be used to measure distance of an object from the sensor, within the useful range of the sensor. It should be understood that the terms conductor and antenna can be used herein interchangeably. In an embodiment, data from a plurality of antennas or conductors can be combined to determine location and/or range, or both location and range of an object with respect to a sensor. In an embodiment, distance mapping from an antenna is computed using a small number of samples at a known distance from the sensor. In an embodiment, distance mapping is computed using two samples at a known distance from the sensor.

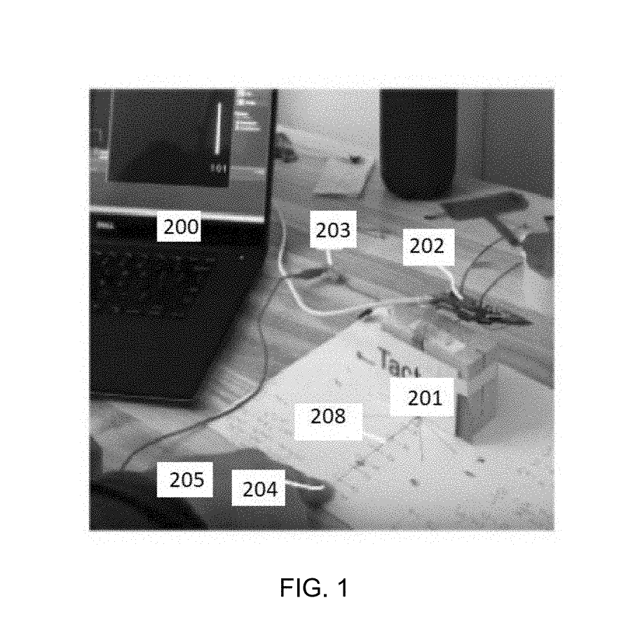

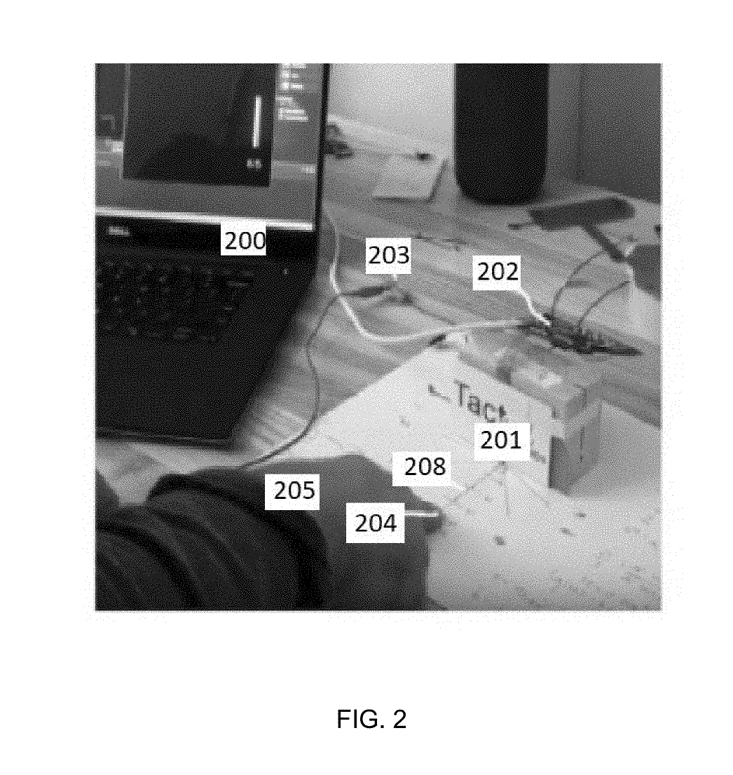

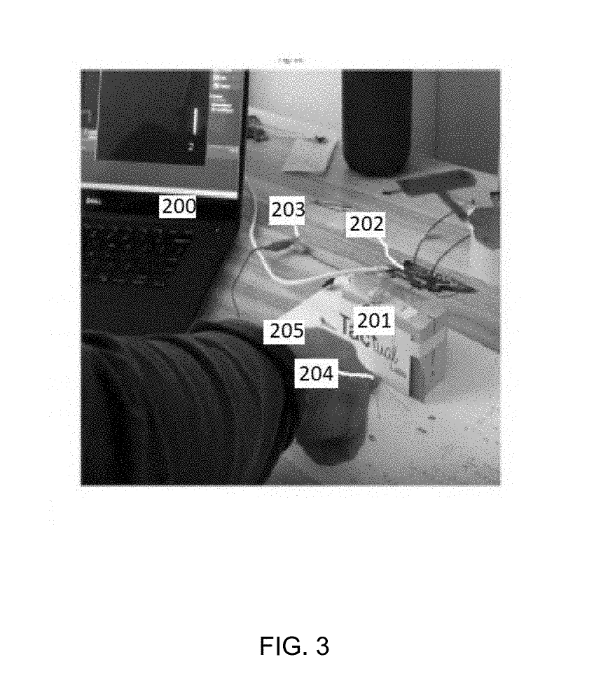

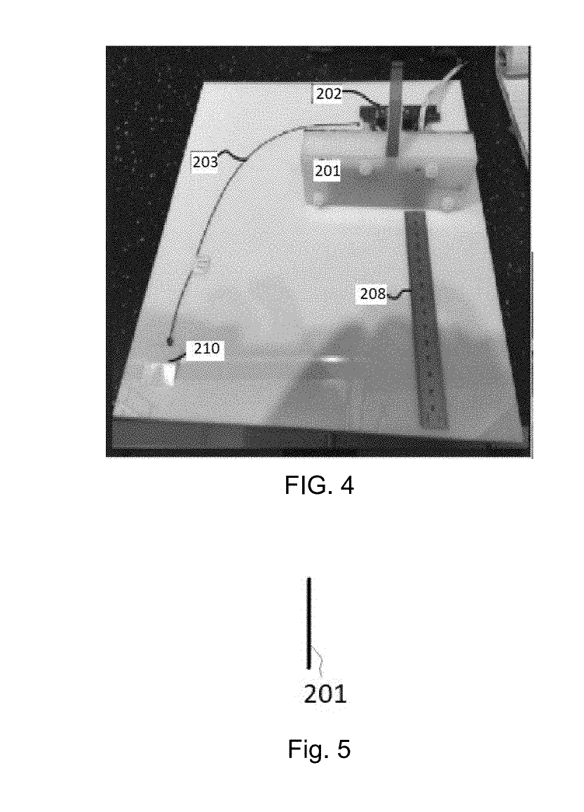

Turning to FIGS. 1-5, shown is an exemplary system illustrating an embodiment of the disclosure. A computer 200 is connected to a control board 202 comprising a signal generator (not shown) and a signal receiver (not shown). The signal generator is operatively connected to a test subject 205 via lead 203. In an embodiment, an electrode conductor 210 is used to operatively connect the lead 203 to the test subject 205. The electrode conductor 210 is an electrically conductive material that is able to transmit signal into the test subject 205. While reference is made to an electrode conductor or simply an electrode it should be understood that the terms electrode or electrode conductor can be used interchangeably with antenna or conductor. A scale 208 is illustrated below the finger 204 of subject 203. The signal receiver is operatively connected to a conductor 201. The conductor 201 may be protected by surface 206.

Conductor 201 may take various shapes and sizes. Generally, conductors that are larger create receivers of signals that create larger coupling. In the illustrated embodiment, the conductor 201 is about 3.6 cm high by 1 cm wide. In an embodiment, the conductor may be up to 1 m or more in height, and up to 10 cm or more in width. In an embodiment, the conductor is much smaller, having no dimension more than 1 cm. In an embodiment, the conductor is much smaller, having a dimension being less than several millimeters.

Turning briefly to FIG. 12, a generally round or oval conductor 1200 may be substituted for the linear conductor 201 shown in FIGS. 1-5. In an embodiment, conductor 201 may be any size, having a diameter (or larger dimension in the case of an oval) of e.g., 2 mm, 3 mm, 5 mm, 1 cm, 2 cm, 5 cm, or can have a diameter (or larger dimension in the case of an oval) larger or smaller than any of these. Moreover, a generally round or oval conductor may not have a center portion (i.e., be shaped like a ring), the ring having a thickness of less than 1 mm, or less than a few millimeters, or less than 1 cm. In an embodiment, a conductor is a ring having an outer diameter (or larger dimension) of 1 cm, and an inner diameter of 8 mm. In an embodiment, a conductor is a ring having an outer diameter (or larger dimension) of 2 cm and an inner diameter of 17 mm. The generally round or oval conductor described in this paragraph is sometimes referred to herein as a spot sensor conductor.

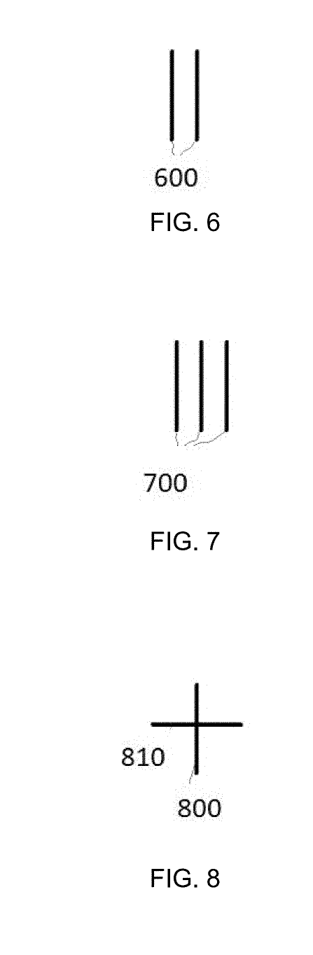

Turning briefly to FIGS. 6 and 7, illustrations are shown of a schematic view of conductor arrangements, having conductors 600 and 700, that can be used in connection with an embodiment of the invention. In an embodiment, a control board (not shown) comprises signal receivers for each of the conductors, so that separate measurements are made from each. The use of multiple conductors may improve information. It will be apparent to one of skill in the art in view of this disclosure that using multiple conductors provides multiple measurements, which are used to localize the source, and thus have more information than merely range from the sensor.

In an embodiment, the signal generator generates a signal. In an embodiment, the signal is a sine wave. In an embodiment, the signal generator generates a signal approximating a sine wave of a predetermined frequency, but the generated signal differs from the predetermined frequencies by having at least one selected from the set of: phase noise, frequency variation, harmonic distortion and other imperfections. In other words, it is not necessary to use a high quality signal.

In an embodiment, the signal generator generates a plurality of orthogonal periodic signals. In an embodiment, the signal generator generates two orthogonal periodic signals. In an embodiment, the signal generator generates three orthogonal periodic signals. In an embodiment, the signal generator generates a plurality of orthogonal signals one for each conductor. So for example, in FIG. 6 there would be two orthogonal signals generated, one for each conductor 600. In FIG. 7 there would be three orthogonal signals generated, one for each conductor 700. In an embodiment, an orthogonal signal can be generated for each conductor that is used in the system.

In an embodiment, a signal or signals generated by the signal generator for infusion ranging can be any at any radio frequency. In an embodiment, the signal generator generates one or more frequencies between 50 KHz and 1 Mhz for ranging. In an embodiment, the signal generator generates one or more frequency up to 5 MHz for ranging. In an embodiment, the signal generator generates one or more frequency up to 3 GHz for ranging. In an embodiment, the signal generator generates one or more frequencies between 10 KHz and 2.5 GHz for ranging. In an embodiment, the signal generator generates a frequency of 245 KHz for ranging.

Because the human body is more lossy at higher frequencies (likely due to, among other things, the effect of being transferred through skin), the frequency or frequencies used for ranging may be selected to take advantage of this effect of skin In an embodiment, multiple frequencies are transmitted over one electrode conductor, such as electrode conductor 210 used in FIGS. 1-4. In an embodiment, the same frequency is transmitted over each of a plurality of electrode conductors. In an embodiment, orthogonal frequencies are transmitted over each of a plurality of electrode conductors, e.g., one frequency is transmitted over a first electrode conductor and a different orthogonal frequency is transmitted over a second electrode conductor. In an embodiment, such first and second electrode conductors are used to infuse the signal onto a human body part. In an embodiment, such first and second electrode conductors are used to infuse the signal onto a conductive object. In an embodiment, multiple frequencies are transmitted over each of a plurality of electrode conductors. Using multiple frequencies may reduce noise, increase dynamic range and/or reduce error. In an embodiment, such multiple frequencies are orthogonal to one another. In an embodiment, a first and second frequency are transmitted over a first electrode conductor and a third and fourth frequency are transmitted over a second electrode conductor. In an embodiment, each of the first, second, third and fourth frequencies are orthogonal to one-another. In an embodiment, a first and second frequency are transmitted over a first electrode conductor and the first and a third frequency are transmitted over a second electrode conductor. In an embodiment, each of the first, second and third frequencies are orthogonal to one-another.

In an exemplary embodiment, first and second electrode conductors are separated onto opposite sides of a hand; each of the two electrode conductors are used to emit one relatively high frequency and one lower frequency (and in an embodiment each of the four frequencies are orthogonal to one another). The greater loss at the higher frequencies can be used to distinguish one digit from another because (other things being equal) the amount of signal on a digit nearer a particular high frequency will be greater than the amount of that high frequency signal on a digit farther from the high frequency source (i.e., electrode).

In an embodiment, signal received by the signal receiver is processed to detect an amount of the generated signal or signals. In an embodiment, the received signal is sampled over a measurement period and a Fourier transform of the signal received during the measurement period is performed. The value in the bin or bins corresponding to the generated signal or signals may be used as a measurement of the amount of the generated signal or signals present in the received signal. In an embodiment, the Fourier transform may be a Discrete Fourier transform. In an embodiment, the Discrete Fourier transform may be calculated using the FFT (Fast Fourier Transform) algorithm.

In an embodiment, the transmitted signal is between 1 v peak-to-peak and 48 v peak-to-peak with respect to the circuit ground of the signal receiver. Higher and lower values will work. In an embodiment, the transmitted signal is at least 1 v peak-to-peak. In an embodiment, the transmitted signal is at least 5 v peak-to-peak. In an embodiment, the transmitted signal is 20 v peak-to-peak. In an embodiment, the transmitted signal is no more than 30 v peak-to-peak. In an embodiment, the transmitted signal is no more than 48 v peak-to-peak for regulatory and/or safety reasons. Generally, the system has low power requirements.

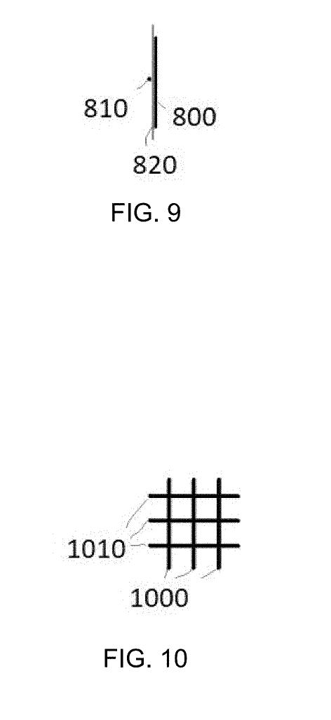

Turning to FIGS. 8 and 9, an arrangement of two conductors 800, 810 is shown. Although the conductors 800, 810 appear to touch in FIG. 8, as is more clearly illustrated in FIG. 9, there is a gap between them. In an embodiment, the two conductors 800, 810 may be disposed on opposite sides of a non-conductive material 820. This sensor configuration can also be used to capacitively detect touch by detecting signals transmitted on one or both of the conductors 800, 810 on the other conductor (e.g., transmitting signals on conductor 800, receiving signals from conductor 810 and detecting levels or changes in the latter). Generally, when capacitively detecting touch, the change in the received signals (i.e., the touch delta) is reflected as a reduction—that is, it has a negative touch delta.

Generally, when using the disclosed ranging system, the delta of the infused signal is a positive touch delta. This permits the systems to interoperate particularly well in that signals representative of touch and range can be received on the same conductors at the same time. In an embodiment, the signal or signals used for detecting touch should be orthogonal to the signal or signals used for ranging as disclosed herein.

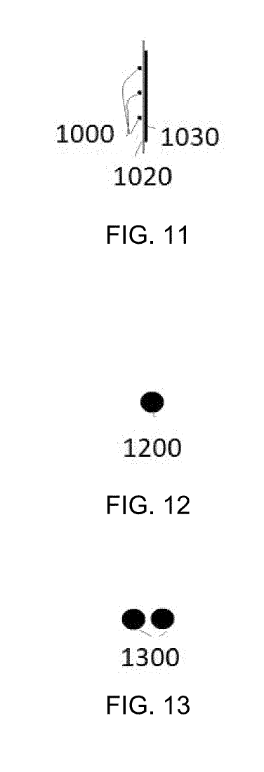

Turning to FIGS. 10 and 11, two sets of conductors 1000, 1010 in a conductor system are shown. Although the conductors 1000, 1010 appear to touch in FIG. 10, as is more clearly illustrated in FIG. 11, there is a gap between them. In an embodiment, the conductors 1000, 1010 may be disposed on opposite sides of a non-conductive material 1020. This sensor configuration can also be used to capacitively detect touch by detecting signals transmitted on one or both of the conductor sets 1000, 1010 on the other conductor (e.g., transmitting signals on conductors 1000 and receiving signals from conductors 1010 (or vice versa), then detecting levels or changes in the received signals). In an embodiment, where signals are simultaneously transmitted on two or more conductors, those signals should be orthogonal to the signal or signals used for ranging as disclosed here. In an embodiment, the signals (ranging or for touch) that are simultaneously employed should have no simple harmonic relationship with each other, i.e., “harmonically unrelated.” (As used herein the phrase harmonically unrelated means having no simple harmonic relationship, thus two signals are not harmonically unrelated if they have a simple harmonic relationship.)

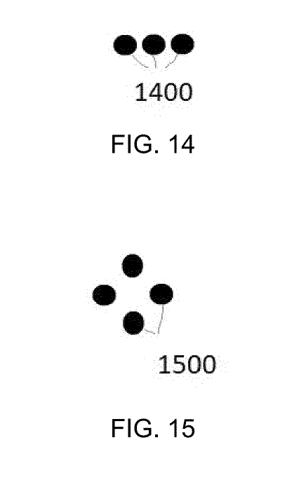

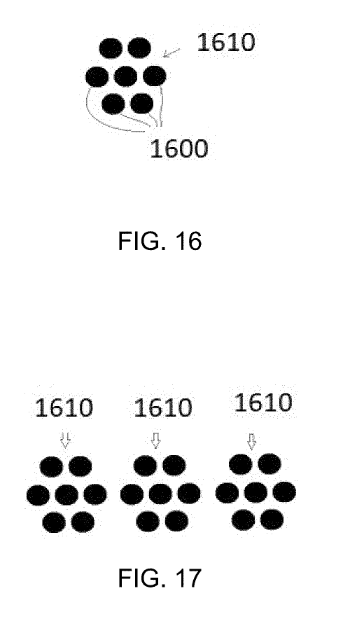

Turning to FIGS. 12, 13, 14, 15, 16 and 17, illustrations are shown of a schematic view of a conductor system using multiple spot sensor conductors 1200, 1300, 1400, 1500, and 1600, that can be used in connection with an embodiment of the invention. As with the conductor systems shown in FIGS. 6 and 7, a control board (not shown) comprises signal receivers for each of the spot sensor conductors 1200, 1300, 1400, 1500, and 1600 so that separate measurements could be made from each. The array 1010 of sensors 1000 shown in FIG. 16 may itself be replicated in a more complex sensor as shown in FIG. 17.

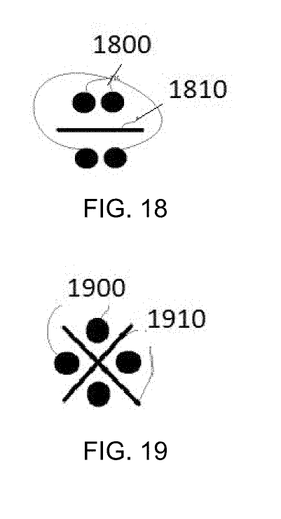

FIGS. 18 and 19 are presented to illustrate the various combinations of conductor shapes and sizes that are within the scope of this disclosure. In FIG. 18 a collection of spot sensor conductors 1800 and linear conductors 1810 are used, substantially combining the conductor systems shown in FIG. 5 (with some rotation) and FIG. 15 (with some rotation). FIG. 19 shows a collection of spot sensor conductors 1900 and linear conductors 1910, substantially combining the conductor systems shown in FIGS. 8 and 9 (with some rotation) and FIG. 15.

In an embodiment, the sensor systems disclosed are used to compute distance mapping from the received signals. In an embodiment, a signal-to-distance map is computed using only two samples at known distances, one sample taken closer to the sensor at a first time period, and one taken from farther away at a second time period. The signal-to-distance map is then used as reference for determining a range based on another signal sensed during another time period and the calculated signal-to-distance map. In an embodiment, a sample is taken very close to the controller (e.g. 2 mm) and another quite far away (e.g. 100 mm). Although 2 mm and 100 mm may be used, any near and far distance within the tolerance of the sensor system can be used. For example, a measurement at 10 mm and 20 mm; a measurement at 3 mm and 80 mm; a measurement at 40 mm and 50 mm; or a measurement at 5 mm and 8 mm, to illustrate with just a few examples.

In an embodiment, the near measurement is as close as practical to the sensor, and the far measurement is at or close to the desired or practical measurement range of the sensor. The practical measurement range may depend on the amount of power in the infused signal, the location of infusion vis-a-vis the object (e.g., finger) being measured and the area of the conductor at which the signal is measured. In an embodiment, a near measurement is made at a location relatively close to the sensor, e.g., 5 mm, and a far measurement is made well within the practical measurement range of the sensor, e.g., 50 mm.

In an embodiment, signal or signals are infused into a hand via a wrist-worn infuser. In an embodiment, signal or signals are infused into a hand via a hand-held infuser. In an embodiment, signal or signals are infused into a user via a seat-born infuser. In an embodiment, signal or signals are infused into a user via an article of clothing infuser. In an embodiment, signal or signals are infused into a user via an article of jewelry or ornamental infuser. In an embodiment, signal or signals are infused into a user via a furniture born infuser. In an embodiment, signal or signals are infused into a user via a keyboard or mouse. In an embodiment, signal or signals are infused into a user via an environmental object, such as a handle or know. As used here, the term infuser refers to the area where the signal or signals are caused to be conducted by the body.

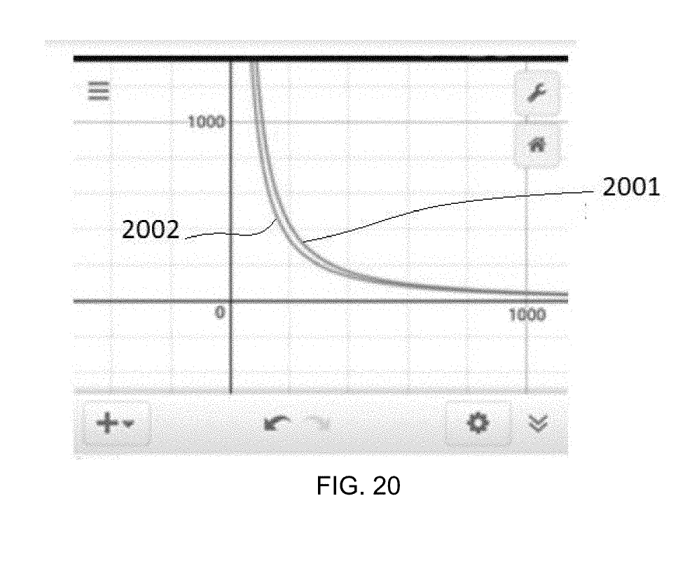

FIG. 20 shows two regressions of infusion signal data. The first equation 2001 was calculated using information from a spot sensor conductor. A copper plate was placed in front of the sensor and a frequency infused into the plate. The curve 2001 shows the response of the spot at 2,4,8,16,32,64,128, and 256 mm. The second equation 2002 is calculated from the same data using only the 2 mm and 256 mm measurements. The curves 2001, 2002 are quite similar. In an embodiment, curves 2001, 2002 are expected to align more closely when the two measurements are at a smaller distance apart, and located at a near location greater than 2 mm and a far location less than 256 mm, e.g., 10 mm and 100 mm, or 5 mm and 50 mm or 4 mm and 32 mm.

In an embodiment, behavior of the infusion signal follows a power function, that is: when a finger, brass rod, or probe moves closer to a sensor the signal value increases exponentially: thus two samples can be used to describe the relationship between signal and distance reasonably well.

In an embodiment of a hand range sensor, a near signal sample and/or a far signal sample may be sufficiently similar across hands such that a default value may be used. In such a system, calibration may be done by any hand. In such a system, calibration may be done once, e.g., at a factory or when a device is received.

In an embodiment, a capacitive touch sensor (or other touch sensor) can be used to identify a near signal by detecting touch or using another method known to identify near contact. In an embodiment, video can be used in calibration to determine distance. In an embodiment, infrared sensor can be used in calibration to determine distance. In an embodiment, a calibration procedure can be used to sample a near or far value at one or along a set of receivers when e.g., a hand is in a known pose.

In an embodiment, near and far measurements are made known at near and far distances. In an exemplary embodiment, the following near and far measurements are made at the near and far distances. The algorithm below may be used in one embodiment of a ranging sensor:

//1. sample signal for near/far distances
float signalFar=1940.0 f; //FFT magnitude
float signalNear=5000.0 f; //FFT magnitude
float distanceNear=2.0 f; //mm
float distanceFar=100.0 f; //mm

//2. calculate coefficients in y=ax̂b where y is in mm, x is sqrt of FFT magnitude;
float b=log(distanceFar/distanceNear)/log(signalFar/signalNear);
float a=distanceFar/pow(signalFar, b);
float mm=a*pow(signal[i], b);

The FFT magnitude is the square root of the sum of the squares of the real and imaginary components of an FFT.

In an embodiment, signals injected (infused) into the fingers of a user can be sensed by multiple devices with heterogeneous sensors, but it is not necessary for such devices to be associated with one or more signal infusers. In other words, as an example embodiment, two users may each use a wearable strap-based signal infuser, each of the wearable strap-based infusers having their own frequency orthogonal signals—and each user may use one or more of a plurality of touch objects that can detect the frequency orthogonal signals of each of the two wearables.

The present systems are described above with reference with reference to diagrams and operational illustrations of controllers and other objects sensitive to hover using FMT or FMT-like systems. It is understood operations performed by the systems may be implemented by means of analog or digital hardware and computer program instructions. Computer program instructions may be provided to a processor of a general-purpose computer, special purpose computer, ASIC, or other programmable data processing apparatus, such that the instructions, which execute via a processor of a computer or other programmable data processing apparatus, implements the functions/acts specified above.

Except as expressly limited by the discussion above, in some alternate implementations, the functions/acts noted in the blocks may occur out of the order noted in the operational illustrations. For example, the order of execution of algorithms shown in succession may in fact be executed concurrently or substantially concurrently, or, where practical, any portions may be executed in a different order with respect to the others, depending upon the functionality/acts involved.

An aspect of the present disclosure is a method of sensing a range of conductive object from a conductor. The method comprises: generating a first signal; infusing the first signal into the conductive object; moving the conductive object to a first known distance from the conductor; detecting the first signal at the conductor during a first time period; determining a first measurement of the detected first signal taken during the first time period; moving the conductive object to a second known distance from the conductor; detecting the first signal at the conductor during a second time period; determining a second measurement of the first signal taken during the second time period; calculating a signal-to-distance map based on the first measurement and the second measurement; sensing a second signal at the conductor during a third time period; and determining a range based on the second signal sensed during the third time period and the signal-to-distance map.

Another aspect of the disclosure is a method of sensing a range of a body part from a conductor comprising. The method comprises generating a first signal using a signal generator; infusing the first signal into the body part via an electrode conductor, detecting the first signal at the conductor during a first time period, wherein the body part is at a first known distance from the conductor; determining a first measurement of the first signal detected during the first time period; detecting the first signal at the conductor during a second time period, wherein the body part is at a second known distance from the conductor; determining a second measurement of the first signal detected during the second time period; calculating a signal-to-distance map based on the first measurement and the second measurement; sensing a second signal at the conductor during a third time period; and determining a range based on the second signal sensed during the third time period and the signal-to-distance map.

Still another aspect of the disclosure is a system for sensing a range of a body part. The system comprises a signal generator for generating a first signal; an electrode conductor adapted to infuse the first signal into the body part via an electrode conductor; a conductor adapted to detect signals generated by the signal generator; a processor operably connected to the conductor, wherein the processor is adapted to determine a first measurement of the first signal during a first time period, wherein the body part is at a first known distance, wherein the processor is adapted to determine a second measurement of the first signal during a second time period, wherein the body part is at a second known distance; wherein the processor is adapted to calculate a signal-to-distance map using the first measurement and the second measurement; and wherein the processor is adapted to determine a range of the body part based on a second signal infused into the body part during a third time period.

Although examples have been fully described with reference to the accompanying drawings, it is to be noted that various changes and modifications will become apparent to those skilled in the art. Such changes and modifications are to be understood as being included within the scope of the various examples as defined by the appended claims.

1. A method of sensing a range of a conductive object from a conductor, comprising:
generating a first signal;
infusing the first signal into the conductive object;
moving the conductive object to a first known distance from the conductor;
detecting the first signal at the conductor during a first time period;
determining a first measurement of the detected first signal taken during the first time period;
moving the conductive object to a second known distance from the conductor;
detecting the first signal at the conductor during a second time period;
determining a second measurement of the first signal taken during the second time period;
calculating a signal-to-distance map based on the first measurement and the second measurement;
sensing a second signal at the conductor during a third time period; and
determining a range based on the second signal sensed during the third time period and the signal-to-distance map.

2. The method of claim 1, wherein the step of determining a first measurement is performed by:
performing a Fourier transform of the first signal detected at the conductor during the first time period; and
taking an amplitude corresponding to the first signal in the Fourier transform of the first signal.

3. The method of claim 2, wherein the step of determining the second measurement is performed by:
performing a Fourier transform of the first signal detected at the conductor during the second time period; and
taking an amplitude corresponding to the first signal in the Fourier transform of the first signal taken during the second time period.

4. The method of claim 1, wherein the conductor is part of an array of conductors.

5. The method of claim 4, wherein the array of conductors comprises linear conductors and spot sensor conductors.

6. The method of claim 4, wherein each conductor in the array of conductors is separated by from another conductor in the array of conductors by a dielectric material.

7. The method of claim 1, wherein the conductor is a spot sensor conductor.

8. The method of claim 7, wherein the conductor is part of an array of conductors.

9. The method of claim 1, further comprising generating a plurality of signals in addition to the first signal and infusing the plurality of signals into the conductive object, wherein each of the plurality of signals is orthogonal with respect to each other.

10. A method of sensing a range of a body part from a conductor, comprising:
generating a first signal using a signal generator;
infusing the first signal into the body part via an electrode conductor;
detecting the first signal at the conductor during a first time period, wherein the body part is at a first known distance from the conductor;
determining a first measurement of the first signal detected during the first time period;
detecting the first signal at the conductor during a second time period, wherein the body part is at a second known distance from the conductor;
determining a second measurement of the first signal detected during the second time period;
calculating a signal-to-distance map based on the first measurement and the second measurement;
sensing a second signal at the conductor during a third time period; and
determining a range based on the second signal sensed during the third time period and the signal-to-distance map.

11. The method of claim 10, wherein the step of determining the first measurement is performed by:
performing a Fourier transform of the first signal detected at the conductor during the first time period; and
taking an amplitude corresponding to the first signal in the Fourier transform of the first signal.

12. The method of claim 11, wherein the step of determining the second measurement is performed by:
performing an Fourier transform of the first signal detected at the conductor during the second time period; and
taking an amplitude corresponding to the first signal in the Fourier transform of the first signal.

13. The method of claim 10, wherein the conductor is part of an array of conductors.

14. The method of claim 13, wherein the array of conductors comprises linear conductors and spot sensor conductors.

15. The method of claim 13, wherein each conductor in the array of conductors is separated by from another conductor in the array of conductors by a dielectric material.

16. The method of claim 10, wherein the conductor is a spot sensor conductor.

17. The method of claim 16, wherein the conductor is part of an array of conductors.

18. The method of claim 10, further comprising generating a plurality of signals in addition to the first signal and infusing the plurality of signal into the conductive object, wherein each of the plurality of signals is orthogonal with respect to each other of the plurality of signals.

19. The method of claim 10, wherein the electrode conductor is adapted to infuse signal into a wrist.

20. A system for sensing a range of a body part, comprising:
a signal generator for generating a first signal;
an electrode conductor adapted to infuse the first signal into the body part via an electrode conductor;
a conductor adapted to detect signals generated by the signal generator;
a processor operably connected to the conductor, wherein the processor is adapted to determine a first measurement of the first signal during a first time period, wherein the body part is at a first known distance,
wherein the processor is adapted to determine a second measurement of the first signal during a second time period, wherein the body part is at a second known distance;
wherein the processor is adapted to calculate a signal-to-distance map using the first measurement and the second measurement; and
wherein the processor is adapted to determine a range of the body part based on a second signal infused into the body part during a third time period.
